(19) United States
(12) Patent Application Publication
(10) Pub. No.: US 2026/0149109 A1
(43) Pub. Date: May 28, 2026

(54) TWO-LAYER CELL SEPARATING ELEMENT, BATTERY MODULE AND MOTOR VEHICLE

(71) Applicant: AUDI AG, Ingolstadt (DE)

(72) Inventor: Sabrina DONNERBAUER, München (DE)

(73) Assignee: AUDI AG, Ingolstadt (DE)

(21) Appl. No.: 19/377,229

(22) Filed: Nov. 3, 2025

(30) Foreign Application Priority Data
Nov. 22, 2024 (DE) 102024134495.4

(51) Int. Cl. H01M 50/291; H01M 10/658; H01M 50/209; H01M 50/211; H01M 50/249; H01M 50/293

(52) U.S. Cl. CPC H01M 50/291; H01M 10/658; H01M 50/209; H01M 50/211; H01M 50/249; H01M 50/293

(57) ABSTRACT

A cell separating element for arrangement between two battery cells of a battery module arranged next to each other in a first direction. The cell separating element has two outer sides opposite one another in the first direction and an edge region delimiting the cell separating element in a second direction. The cell separating element is provided with a first section and a second section adjoining it in the second direction and encompassing the edge region, which has a higher heat resistance and/or abrasion resistance than the first section.

### FIELD

The invention relates to a cell separating element for arrangement between two battery cells of a battery module arranged next to each other in a first direction, wherein the cell separating element has two outer sides opposite one another in the first direction and an edge region delimiting the cell separating element in a second direction. Furthermore, the invention also relates to a battery module with such a cell separating element and to a motor vehicle.

### BACKGROUND

In batteries, for example automotive batteries, so-called cell separating elements, which can also be referred to as cell intermediate material, are often used between the battery cells. These sometimes serve different purposes, for example the thermal insulation of the battery cells from one another. In the event of thermal runaway of a battery cell, gas typically escapes from such a battery cell. For controlled degassing of battery cells, these typically have releasable cell degassing openings, which can also be referred to as cell vents, and which can be implemented, for example, as a bursting membrane or similar.

In the event of such a gas leak, neighboring cells should ideally be protected as well as possible from contact with such hot gas. However, this cannot yet be reliably guaranteed in every situation or can only be achieved with very complex means. It would therefore be desirable to enable improved neighboring cell protection.

WO 2024/143391 A1 describes a thermal insulation layer comprising an elastic layer which in turn has two main surfaces perpendicular to a thickness direction and end surfaces extending substantially parallel to the thickness direction, as well as a bead-suppressing layer extending along the end surfaces. This can suppress excessive outward curvature of the end surfaces parallel to the thickness direction and suppress a decrease in thermal insulation due to thickness reduction.

WO 2021/181951 A1 describes a thermal insulation material for a battery module, comprising a thermal insulation layer, a first and a second substrate, between which the thermal insulation layer is located. The thermal insulation layer consists of a porous material. The substrates prevent the porous structure of the thermal insulation layer from powdering off.

### SUMMARY

The object of the present invention is to provide a cell separating element, a battery module and a motor vehicle which make it possible to increase the protection of neighboring cells in the event of a thermal runaway of a battery cell.

This object is achieved by a cell separating element, a battery module and a motor vehicle. Advantageous embodiments of the invention are the subject matter of the description, and the figures.

A cell separating element according to the invention for arrangement between two battery cells of a battery module arranged next to each other in a first direction has two outer sides opposite one another in the first direction and an edge region delimiting the cell separating element in a second direction. The cell separating element comprises a first section and a second section adjoining the first section in the second direction and comprising the edge region, which second section has a higher heat resistance and/or abrasion resistance than the first section.

The second section thus makes it possible to provide a particularly high heat barrier and/or abrasion barrier, especially in the edge region between two battery cells, which, in conventional cell separating elements, is particularly susceptible to potential gas penetration in the event of outgassing from a battery cell during a thermal runaway of such a battery cell. This is based on the knowledge that when a battery cell outgasses, the cell housing can be damaged or partially destroyed due to the strong heat development and/or pressure despite the provided releasable cell degassing opening, which also allows gas to escape at other locations in the cell. Such damage to the cell housing usually occurs near the cell vent and is not only limited to the cell side in which the cell vent is located, but can also extend to the adjacent side walls of the cells. Such undesirable damage or opening of the cell housing primarily affects those parts of the cell housing that are adjacent to the edge region of the cell separating element. The second section of the cell separating element can now provide a heat protection and/or abrasion protection barrier in that particular region, but at the same time also stabilize the adjacent region of a cell housing wall. This reduces the probability of such a cell housing wall being destroyed, and should this nevertheless occur, the second section can particularly efficiently shield neighboring cells from contact with the escaping gas.

The first section of the cell separating element, on the other hand, can be designed to be optimized with regard to other requirements, for example with regard to the best possible thermal insulation and/or the best possible swelling compensation, i.e. the compensation of a change in the thickness of the battery cells in the course of a charging-related and/or aging-related swelling of the battery cells. Due to the increased heat barrier and/or abrasion barrier in the edge region, neighboring cells of a thermally runway battery cell can advantageously be protected much better without negatively affecting other properties or functions of the cell separating element during normal operation or in normal operating conditions.

The two sections should be part of a one-piece cell separating element. They should therefore not represent separate components. The two sections can be manufactured as separate parts which are then joined together, e.g. glued together, welded, or similar, or the sections can also be materially joined together during their manufacture by a suitable manufacturing process.

The two outer sides of the cell separating element opposite each other in the first direction can be designed for flat contact with the cell sides of the battery cells adjacent to the cell separating element in and against the first direction. In other words, when the cell separating element is arranged as intended in a battery module, the two outer sides should face the two cell sides of the battery cells arranged next to this cell separating element and should lie flat against them. The cell separating element is preferably used in a battery module with a cell stack comprising a plurality of battery cells arranged next to each other in a stacking direction. The stacking direction then corresponds to the first direction defined above. The battery cells in the cell stack are preferably arranged with their sides having the largest surface area facing each other. The geometry of the cell separating element can essentially correspond to the geometry of these cell sides with the largest surface area. The dimensions of the cell separating element perpendicular to the first direction may also correspond substantially to these adjacent cell sides, although the dimensions do not have to match exactly. The second direction can additionally be defined perpendicular to said first direction.

The fact that the second section has a higher heat resistance than the first section can mean that heat-related destruction of the second section occurs at higher temperatures than in the first section and/or at the same temperature but later than in the first section. Abrasion resistance refers in particular to mechanical resistance to abrasion. Abrasion refers in particular to abrasive wear, which causes a loss of material in a particular component due to a rubbing or grinding action, such as caused by particles contained in the escaping gas during thermal runaway of a battery cell. Higher abrasion resistance can be achieved, for example, by a higher hardness and/or strength of the material of the second section of the cell separating element. The material of the second section can therefore have a higher hardness and/or strength than the material from which the first section is formed.

Accordingly, it represents a further advantageous embodiment of the invention if the first section is formed from a different material than the second section. This makes it easy to implement different thermal and/or mechanical properties for the second section than for the first section.

For example, the first section may be formed from a material that has a lower hardness and/or lower rigidity and/or lower strength and/or higher flexibility and/or higher elasticity than the material of the second section. The first material from which the first section is formed may also have a lower temperature resistance than the second material from which the second section is formed.

Materials that are very heat-resistant and/or abrasion-resistant and are therefore suitable as material for the second section of the cell separating element are widely known. Examples include ceramics, mica, metals, but also plastics, e.g. with heat-resistant and/or abrasion-resistant fillers and/or with reinforcing fibers, or similar.

According to a further advantageous embodiment of the invention, the cell separating element is composed of the first section and the second section. In other words, the second section should have a higher heat resistance and/or abrasion resistance than the rest of the cell separating element. It can therefore be provided that the cell separating element is designed with a higher heat resistance and/or abrasion resistance only in a single edge region, namely the one that delimits the cell separating element in the second direction. This in turn is based on the finding that higher heat resistance and/or abrasion resistance brings advantages primarily in only a single edge region of the cell separating element, and specifically in that edge region which, when the cell separating element is arranged as intended in a cell stack, is arranged next to the cell sides with the releasable cell degassing openings from which gas escapes in the event of thermal runaway of a battery cell. In general, the cell separating element can therefore have four edge regions, namely two edge regions which delimit the cell separating element in and against the second direction, and two further edge regions which delimit the cell separating element in and against a third direction, which can be defined perpendicular to the first and second directions. The edge region covered by the second section can, for example, also be referred to as the first edge region. The remaining three edge regions thus do not have to be designed with a higher heat resistance and/or abrasion resistance, or at least with the exception of their corner regions, which are also part of the first edge region.

According to a further advantageous embodiment of the invention, the first section forms at least a major part of the cell separating element relative to a total volume of the cell separating element. The second section therefore only makes up a very small part of the cell separating element. In particular, the second section can also be limited to the edge region of the cell separating element, wherein in particular such an edge region is to be understood as not only the end face delimiting the cell separating element in the second direction, but also a small region of the cell separating element adjoining this end face.

According to a further advantageous embodiment of the invention, the first section has a first height in the second direction and the second section is limited to the edge region and has a second height in the second direction which is smaller than the first height. The first height can be several centimeters, for example more than 5 centimeters or more than 10 centimeters. The second height can be less than 5 centimeters, for example. It is therefore sufficient, for example, if the second section is designed as a small strip-shaped section on one edge of the cell separating element. Thus, the properties provided by the first section, which have a positive effect on the service life of the battery cells, can be provided unchanged over a major part of the cell separating element. These positive properties are accordingly not significantly affected by the small edge region provided by the second section.

According to a further advantageous embodiment of the invention, the cell separating element has a width in a third direction and the second section extends over the entire width of the cell separating element, in particular with a constant second height. Thus, the heat protection barrier and/or abrasion barrier provided by the second section can be provided over the entire width of the cell separating element and accordingly over the entire width of the space between two battery cells when arranged as intended in a battery module. This allows neighboring cell protection to be optimized.

The second section does not necessarily have to have a constant second height across the width. However, the embodiment with a constant second height simplifies the production of the cell separating element.

The cell separating element can have a substantially cuboid geometry and a thickness in the first direction that is significantly smaller than a height of the cell separating element in the second direction and a width of the cell separating element in the third direction. The thickness of the cell separating element can, for example, be a few millimeters. The thickness of the cell separating element can be constant across the entire cell separating element or can vary as needed.

Furthermore, the invention also relates to a battery module having a cell separating element according to the invention or one of its embodiments. The advantages described in relation to the cell separating element according to the invention and its embodiments apply in the same way to the battery module according to the invention.

Furthermore, it can be provided that the battery module comprises a cell stack with a plurality of battery cells arranged next to each other in the first direction, and the cell separating element is arranged in an intermediate space between two battery cells of the plurality of battery cells arranged next to each other in the first direction. It can also be provided that the battery module also comprises a plurality of cell separating elements according to the invention or a plurality of cell separating elements according to exemplary embodiments of the invention. A cell separating element can be arranged between every two battery cells arranged next to each other in the stacking direction.

In the present case, the battery cells can be lithium-ion cells, for example. In particular, the battery cells can be prismatic battery cells or pouch cells.

According to a further particularly advantageous embodiment of the invention, the battery cells each have a cell bottom side delimiting the respective battery cell in the second direction, as well as a releasable cell degassing opening arranged in the cell bottom side. Thus, the edge region which delimits the cell separating element in the second direction and which is encompassed by the second heat-resistant and/or abrasion-resistant second section is arranged just next to these cell bottom sides in which the respective releasable cell degassing openings are provided. This means that a very good heat protection barrier and/or abrasion barrier can be provided between the cells by the second section of the cell separating element, especially in the region of these releasable cell degassing openings.

According to a further very advantageous embodiment of the invention, the battery module comprises a base plate which is arranged in the second direction below the cell stack, wherein the bottom sides of the battery cells and the edge region of the cell separating element adjoin the base plate and/or adjoin a layer arranged between the base plate and the cell stack, in particular a heat protection layer. Because both the battery cells with their respective cell bottom sides and the cell separating element are adjacent to the base plate or the heat protection layer located thereon, it can advantageously be provided that in this region of the intermediate space, which is between two bottom sides of neighboring battery cells, there is no gap or free space that can easily be penetrated by a gas escaping from a battery cell, since the edge region of the cell separating element arranged between these battery cells also reaches to the base plate or the layer arranged thereon and is adjacent to it. This provides a particularly reliable barrier between the battery cells in the event of thermal runaway of a battery cell.

According to a further very advantageous embodiment of the invention, the cell bottom sides of the battery cells lie essentially in a common plane, to which the edge region of the cell separating element adjoins flush with the cell bottom sides. When manufacturing a battery module, the edge region of the cell separating element can thus be aligned flush with the bottom sides of the battery cells. As already described above, this makes it possible to ensure that a reliable barrier between the battery cells can be provided by the edge region of the cell separating element located there, especially in the region of the cell bottom sides, in which the respective releasable cell degassing openings are located. Gaps in this part of the intermediate space between the battery cells can thus advantageously be avoided. Furthermore, this makes it possible that the dimensions of the cell separating element in the second and/or third direction do not have to exactly match the dimensions of the cell sides adjacent on both sides in the first direction. Manufacturing-related tolerances may still be present and the cell separating element does not have to completely cover the entire cell sides that face the outer sides of the cell separating element. Nevertheless, this flush alignment of the edge region with the plane in which the cell bottom sides of the battery cells are located can provide a reliable and gapless seal between the battery cells.

However, it is also conceivable that the cell bottom sides of the battery cells do not lie exactly in a common plane and, additionally or alternatively, the cell separating element is not exactly flush with the cell bottom sides, for example if the cell stack is positioned on a base plate with an optional layer arranged thereon as described above, and for example the layer is designed to compensate for certain height tolerances with respect to the second direction. This also allows a reliable seal between the battery cells to be provided by the second section of the cell separating element.

The base plate can, for example, be provided in the form of a base sheet metal. In addition, the base sheet metal can comprise predetermined passage regions or predetermined breaking points that are opposite the respective releasable cell degassing openings of the battery cells located above it with respect to the second direction. This facilitates the passage of gas through the base plate in the event of degassing and enables efficient gas removal, which in turn benefits the protection of neighboring cells.

Furthermore, the invention also relates to a battery having a battery module according to the invention or one of its embodiments. The battery can also comprise a plurality of such battery modules. The battery can be designed for example as a high-voltage battery or a medium-voltage battery, for example. The battery can be, for example, a traction battery of an electric vehicle.

Moreover, the invention also relates to a motor vehicle having a battery module according to the invention or one of its embodiments and/or having a battery according to the invention or one of its embodiments. The motor vehicle may be designed as an electric vehicle.

The motor vehicle according to the invention is preferably designed as an automobile, in particular as a passenger car or truck, or as a passenger bus or motorcycle.

The invention also includes further developments of the battery module according to the invention and of the motor vehicle according to the invention, as already described in connection with the further developments of the cell separating element according to the invention. For this reason, the corresponding developments of the battery module according to the invention and of the motor vehicle according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic illustration of a battery module according to an exemplary embodiment of the invention; and

FIG. 2 shows a schematic illustration of a cell separating element according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

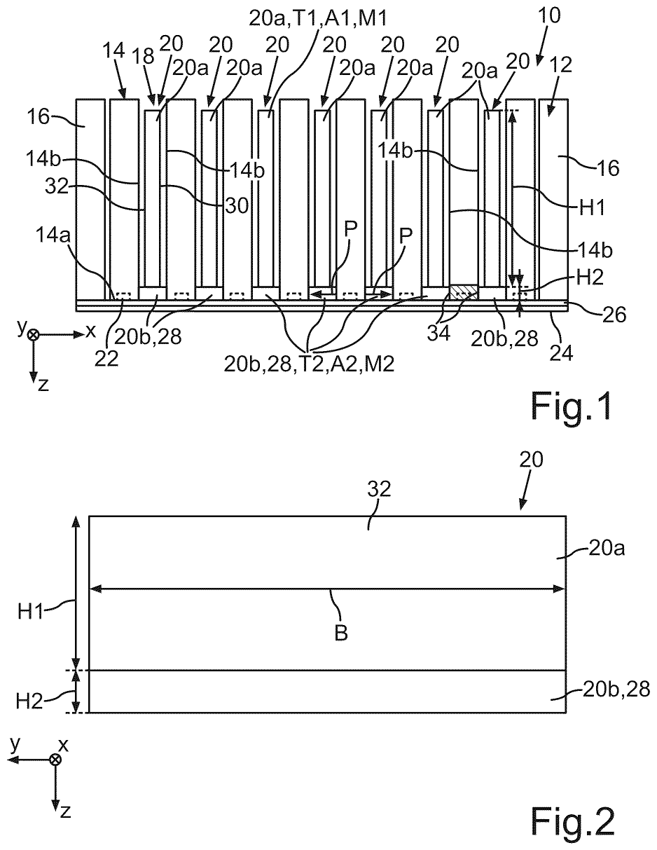

FIG. 1 shows a schematic illustration of a battery module 10 according to an exemplary embodiment of the invention. The battery module 10 comprises a cell stack 12 which comprises a plurality of battery cells 14 arranged next to each other in a stacking direction. The stacking direction presently corresponds to the x-direction shown, which had been previously also indicated as the first direction. The z-direction corresponds to the previously indicated second direction and the y-direction corresponds to the previously indicated third direction. The cell stack 12 can also be limited in and against the x-direction by two plates 16, for example aluminum plates 16. Between each two battery cells 14 arranged next to each other in the stacking direction x there is also a cell separating element 20 according to an exemplary embodiment of the invention. The cell separating element 20 in question is therefore located in an intermediate space 18 between two battery cells 14 arranged next to each other in the stacking direction x.

Each of the battery cells 14 has a bottom side 14a in which a releasable cell degassing opening 22, also called cell vent 22, is located. This can also be designed, for example, as a pressure relief valve or bursting membrane. If a thermal runaway occurs in the battery cell 14 in question, it will outgas via this releasable cell degassing opening 22. The battery module 10 may also comprise a base plate 24 with a heat protection layer 26 arranged thereon, on which the cell stack 12 is arranged.

The bottom sides 14a of the respective battery cells 14 as well as the edge regions 28 of the cell separating elements 20 can be arranged in contact with the layer 26 or the base plate 24 if the layer 26 is not present. In particular, the battery module 10 can be manufactured such that the bottom sides 14a of the cells 14 as well as those of the cell separating elements 20 are aligned flush with each other or are aligned with respect to the base plate 24. As a result, no gaps remain in the lower region of the intermediate space 18 and a particularly reliable sealing of the cells 14 relative to one another can be provided precisely in this lower region by the second section 20b of the cell separating element, which will now be described in more detail below.

In the present example, each cell separating element 20 is divided into a first section 20a in the z-direction and a second section 20b directly adjacent to the first section in the z-direction and comprising an edge region 28 of the cell separating element 20. The second section 20b can also represent only this edge region 28, which delimits the cell separating element 20 with respect to the z-direction. A large part of the cell separating element 20 is here provided by the first section 20a. The edge region 28 or the second section 20b therefore represents only a small part of the cell separating element 20. For example, the first section 20a may have a first height H1 with respect to the z-direction, which is greater, in particular significantly greater, than a second height H2 of the second section 20b with respect to the z-direction.

The second section 20b is now advantageously designed such that it has a heat resistance T2 and/or abrasion resistance A2 which is greater than a heat resistance T1 or abrasion resistance A1 associated with the first section 20a or its material M1. This makes it possible to provide an increased barrier between the cells 14, particularly with respect to the z-direction shown, in the lower region of the intermediate space 18, to which the cell sides 14a with the cell vents 22 also adjoin. In particular, the regions 34 of the cell sides 14b and the cell vent edges are particularly susceptible to damage in the event of degassing. The cell vent edge represents the edge of the cell housing that is located between the cell housing bottom side 14a and the cell housing side wall 14b that faces the cell separating element 20. The cell housing thus has two such cell vent edges, which thus delimit the cell housing bottom side 14a in and against the stacking direction x.

In the event of damage, gas could also escape from the sides of the cells in conventional modules and reach the neighboring cells, wherein this potential gas path is designated P. This can now be specifically blocked or sealed by the sections 20b. In particular, the sensitive regions 34 of the cell housings can be additionally stabilized from the outside by these sections 20b, which also makes damage or opening of these in the event of degassing even less likely. Precisely for this purpose, it is particularly advantageous that, at least in the case of a non-full coverage of the cell 14, the cell separating element 20 is positioned flush with the cell vent edge.

Even though, for reasons of clarity, the first section 20a is shown here in such a way that it does not completely fill the intermediate space 18 in the x-direction between the cells 14, the cell separating element 20 can nevertheless adjoin the respective cell sides 14b facing the cell separating element 20 or lie flat against them. The cell separating element thus has two outer sides 30, 32 with respect to the x-direction shown, which can lie flat against the cell sides 14b of the neighboring cells 14. These outer sides 30, 32 each extend over both the first section 20a and the second section 20b of the cell separating element 20.

In order to provide these with different properties with regard to heat resistance and/or abrasion resistance, the second section 20b can be formed from a different material M2 than the material M1 from which the first section 20a is formed. The second material M2 may, for example, be more heat-resistant and/or stronger and/or stiffer and/or harder than the first material M1.

The first section 20a of the cell separating element 20 can be designed like a conventional cell separating element, in particular it can be designed in any desired manner. In particular, this first section 20a does not have to consist of a homogeneous material M1, but can optionally also have differently formed regions, layers and the like. However, the second region or second section 20b of the cell separating element 20 is designed such that its heat resistance T2 or abrasion resistance A2 is higher than that of the first section 20a and thus each of its sub-regions and in particular also higher than that of the entire remaining cell separating element 20.

FIG. 2 shows a schematic representation of a cell separating element 20 in a plan view in the x-direction shown, according to an exemplary embodiment of the invention. Here, the cell separating element 20 is shown again as an example in a plan view on one of its outer sides 32. The cell separating element 20 can be designed as already described in FIG. 1. It is therefore divided into two sections in the z-direction, namely the first section 20a and the second section 20b. The second section 20b represents the edge region 28 of the cell separating element 20, which delimits the cell separating element 20 in the z-direction. This edge region 28, and thus also the second section 20, extends over the entire width B of the cell separating element 20 in the y-direction. The two sections 20a, 20b therefore have the same width B, which is constant in particular in the z-direction. This allows reliable neighboring cell protection to be provided across the entire width B. The battery cells 14 preferably have approximately the same width B in the y-direction as the cell separating element 20.

Overall, the examples show how the invention can provide a two-layer cell intermediate material in the form of the described cell separating element. If the degree of coverage of the cell is not complete, it is advantageous to place the cell intermediate material flush with the cell vent edge, i.e. to place it flush with the edge of the cell housing between the cell housing bottom side and the cell housing side wall facing the cell separating element. The cell housing thus has two such cell vent edges, which thus delimit the cell housing bottom side n and against the stacking direction. If the coverage is not complete, an unprotected region is created with conventional cell intermediate materials, especially with unstable cell cans, i.e. cell housings, and thus with an opening of the cell can at the side surfaces, which allows a direct attack on the neighboring cell by the escaping gas flow, especially if no cell intermediate material is present at this location. By means of the cell separating element according to the invention or its embodiments, this region in particular can be particularly protected, which is made possible in particular by a reinforced cell intermediate material precisely in this region, which is preferably particularly designed for abrasion resistance. By designing it as a two-part cell intermediate material, or more precisely as a one-part cell intermediate material with two different regions, i.e. sections, with different properties, it is possible to provide reinforcement in the edge region and, in particular preferably also to place it flush with the vent edge.

1. A cell separating element for arrangement between two battery cells of a battery module arranged next to each other in a first direction, wherein the cell separating element has two outer sides opposite one another in the first direction and an edge region delimiting the cell separating element in a second direction,
wherein the cell separating element comprises a first section and a second section adjoining it in the second direction and encompassing the edge region, which has a higher heat resistance and/or abrasion resistance than the first section.

2. The cell separating element according to claim 1, wherein the first section is formed from a different material than the second section.

3. The cell separating element according to claim 1, wherein the cell separating element is composed of the first section and the second section.

4. The cell separating element according to claim 1, wherein the first section has a first height in the second direction, and the second section is limited to the edge region and has a second height in the second direction that is smaller than the first height.

5. The cell separating element according to claim 1, wherein the cell separating element has a width in a third direction, and the second section extends across the entire width of the cell separating element, in particular with a constant second height.

6. A battery module with a cell separating element according to claim 1, the battery module comprises a cell stack with a plurality of battery cells arranged next to each other in the first direction and the cell separating element is arranged in an intermediate space between two battery cells of the plurality of battery cells arranged next to each other in the first direction.

7. The battery module according to claim 6, wherein the battery cells each have a cell bottom side delimiting the respective battery cell in the second direction, and a releasable cell degassing opening arranged in the cell bottom side.

8. The battery module according to claim 6, wherein the battery module comprises a base plate which is arranged in the second direction below the cell stack, wherein the bottom sides of the battery cell and the edge region of the cell separating element are adjacent to the base plate and/or to a layer, in particular a heat protection layer, arranged between the base plate and the cell stack.

9. The battery module according to claim 6, wherein the cell bottom sides of the battery cells lie in a common plane, to which the edge region of the cell separating element adjoins flush with the cell bottom sides.

10. A motor vehicle having a battery module according to claim 6.

11. The cell separating element according to claim 2, wherein the cell separating element is composed of the first section and the second section.

12. The cell separating element according to claim 2, wherein the first section has a first height in the second direction, and the second section is limited to the edge region and has a second height in the second direction that is smaller than the first height.

13. The cell separating element according to claim 3, wherein the first section has a first height in the second direction, and the second section is limited to the edge region and has a second height in the second direction that is smaller than the first height.

14. The cell separating element according to claim 2, wherein the cell separating element has a width in a third direction, and the second section extends across the entire width of the cell separating element, in particular with a constant second height.

15. The cell separating element according to claim 3, wherein the cell separating element has a width in a third direction, and the second section extends across the entire width of the cell separating element, in particular with a constant second height.

16. The cell separating element according to claim 4, wherein the cell separating element has a width in a third direction, and the second section extends across the entire width of the cell separating element, in particular with a constant second height.

17. The battery module according to claim 7, wherein the battery module comprises a base plate which is arranged in the second direction below the cell stack, wherein the bottom sides of the battery cell and the edge region of the cell separating element are adjacent to the base plate and/or to a layer, in particular a heat protection layer, arranged between the base plate and the cell stack.

18. The battery module according to claim 7, wherein the battery module comprises a base plate which is arranged in the second direction below the cell stack, wherein the bottom sides of the battery cell and the edge region of the cell separating element are adjacent to the base plate and/or to a layer, in particular a heat protection layer, arranged between the base plate and the cell stack.

19. The battery module according to claim 8, wherein the battery module comprises a base plate which is arranged in the second direction below the cell stack, wherein the bottom sides of the battery cell and the edge region of the cell separating element are adjacent to the base plate and/or to a layer, in particular a heat protection layer, arranged between the base plate and the cell stack.
